(19) United States
(12) Patent Application Publication
(10) Pub. No.: US 2011/0139351 A1
(43) Pub. Date: Jun. 16, 2011

(54) Method for Fast Cure of a Composite Wrap

(75) Inventor: Joseph Alan Morton, Tulsa, OK (US)

(73) Assignee: TDW Delaware, Inc.

(21) Appl. No.: 12/636,968

(22) Filed: Dec. 14, 2009

(51) Int. Cl. B65H 81/00; B32B 37/02; B32B 38/00

(52) U.S. Cl. 156/185

(57) ABSTRACT

A system and method for fast curing a composite material includes the steps of wrapping an uncured composite material about an external surface of a tubular or non-tubular structural member so that at least one layer of the uncured composite material encircles a portion of the member and then placing an electrically conductive portion of the wrapped, uncured composite material in circuit relationship to a voltage source. The electrically conductive portion includes a two or more tabs which may encircle a portion of the wrapped, uncured composite material. Insulation may be provided to insulate the member from the electrically charged composite material or to insulate layers of the composite material from one another. The electric current passing through the conductive fibers of the material, which are typically carbon fibers, generates heat within the composite material that works to reduce the curing time. Once cured, the voltage source is removed.

### BACKGROUND OF THE INVENTION

1. Field of Invention

The present invention relates generally to the use of composite wraps for reinforcing and repairing piping, pipelines, and other types of tubular and non-tubular (e.g. square, I-beam, flat plate) structural members. More particularly, the present invention relates to methods for improving the quality of the composite wrap repair while at the same time reducing the cure time.

2. Prior Art

Piping systems, pipelines, and other tubular and non-tubular structural members are subject to defects such as arc burns, corrosion, cracks, dents, fretting, gouges, and grooves that compromise structural integrity. Because of the potential of a defect to cause catastrophic failure, pipeline operators employ various external and internal inspection methods to evaluate pipeline conditions and identify defects. When a defect is identified, various repair methods are employed based upon such factors as defect location, type, and size. Repair methods include grinding, weld deposit, sleeves, clamps, and hot tapping. Preferably, operators would like to make the repair without having to shutdown or reduce the flow of the pipeline.

An advance in repairs has been the use of composite materials. The composite is typically multiple layers of carbon, glass, or aramid fibers bound together by a polymeric matrix consisting of either epoxy, polyurethane, or vinlyester in the form of a patch or wrap. Pipeline repair provides an example. First, the surrounding pipeline surfaces are prepared to receive the composite wrap and filler by grit-blasting or an equivalent process. In a typical repair, putty filler is used to fill any voids in the pipeline created by the defect and to taper uneven welds or misaligned pipes. The surface is then prepared with low viscosity polymeric primer to ensure bonding and load transfer between the repair and the substrate. The structural reinforcing fibers, or fabric, are then saturated with a liquid polymer and the wet fibers are wrapped around the outer pipeline surface. The wrap is typically allowed to cure at ambient temperature and atmospheric pressure.

Other types of composite wrap systems include a pre-impregnated system and pre-cured coil. A pre-impregnated system is one that has a polymer applied onto the fibers at the factory; however, the polymer is not fully cured at this stage. Reaction of the polymer is achieved by the addition of heat or a chemical (including water) to the pre-impregnated fiber. This means that a liquid polymer is applied to dry fibers at a factory and the reaction is suspended until heat or some type of chemical is added to the system once it is applied to the pipeline. In a pre-cured coil, the repair system is shipped from the factory with the polymer completely reacted onto the fibers. Each layer of the repair system is therefore pre-cured and is pre-formed to the pipeline outer diameter. In the field, this pre-cured coil is pulled around the pipeline and an adhesive is applied to each layer to bond the coil together.

Composite wrap repairs can be difficult and labor intensive due in part to the handling of the wet fibers and the time-sensitive nature of the liquid polymer. As the polymer set-up time or pot life expires, the liquid polymer becomes more viscous and difficult to mold and shape. The pot life of many liquid polymers is only a few minutes. In contrast to pot life, cure time may be day or several days. Long cure times can affect the quality of the final repair because ambient and pipeline conditions often change during the cure time. Typically, cure time is dependent on available heat from the pipeline surface or surroundings. To speed the cure, external heat or heat blankets are used.

Applying heat to a pipeline repair system to affect the quality of the repair is well known in the art—see e.g. U.S. Pat. No. 3,379,218 to Conde whereby a heater, which may be any conventional heater, i.e., an infrared or hot air heater, is positioned around the closure member and actuated to seal the closure sleeve—and apparatuses and methods have been developed for applying heat to composite repair systems to reduce cure time. For example, U.S. Pat. No. 6,276,401 to Wilson discloses a high temperature composite pipe wrapping system whereby an external heating element is placed about the wrapping of pre-impregnated webbing material and energized to apply sufficient heat for a sufficient period of time to completely cure the webbing. Similarly, U.S. Pat. No. 7,534,321 to Fawley discloses a composite reinforced pipeline having a composite reinforcement wrapped circumferentially about a core whereby the joint tape and woven fabric may be cured through the application of heat from an induction heater placed adjacent to the pipeline. United States Patent Publication No. 2004/0217110 to Gray discloses a heating blanket, made of, in one embodiment, a layer of carbon material, which can maintain sufficient contact with a composite assembly as a contour of the composite assembly's surface changes so as to adequately cure regions of an assembly that would otherwise be difficult to cure. Last, United States Patent Publication No. 2008/0272110 by Kamiyama et al. discloses an internal repair system that makes use of pipe lining material arranged about a balloon or mandrel whereby electric power is supplied to the lining material to generate heat to cure a thermosetting resin impregnated into the lining material.

With the exception of Kamiyama et al., all the prior art composite repair systems are applied to the outside of the pipeline and make use of a supplemental heat source to supply heat to the surface of the composite wrap repair. Kamiyama et al. does not require a supplemental heat source but applies the composite repair to the inside of the pipeline. Therefore, Kamiyama et al.'s system cannot be deployed when pipeline product is in the pipeline or when the pipeline is under pressure. Furthermore, Kamiyama et al.'s lining must be specially made, with the conductive threads of the lining material, which are polyester fibers covered with electrically conductive carbon, oriented and arranged in a certain way.

### SUMMARY OF THE INVENTION

A system and method according to this invention for fast curing a composite material includes the steps of wrapping an uncured composite material about an external surface of a tubular or non-tubular (e.g. square, I-beam, flat plate) structural member so that at least one layer of the uncured composite material encircles a portion of the member and placing an electrically conductive portion of the uncured composite material in circuit relationship to a voltage source. Heat generated by the electric current passing through the conductive fibers of the material, which are typically carbon fibers, works to reduce the curing time. Once cured, the voltage source is removed.

In one embodiment of the system and method, one or more layers of insulation are provided between the external surface of the member and the uncured composite material so as to insulate the member from the electrically charged uncured composite material. In another embodiment of the system and method, the layer or layers of insulation are provided between two layers of the uncured composite material so as to insulate one layer of composite material from the other.

The electrically conductive portion of the composite wrap may include two or more tabs located apart from one another and toward an end of the wrapped uncured composite material. The tabs—which may be localized tabs or tabs that encircle a portion of the wrapped uncured composite material—are placed in circuit relationship to the voltage source and the electrically conductive fibers of the composite wrap. The tabs may be removed once the composite material is cured.

### BRIEF DESCRIPTION OF THE DRAWINGS

FIG. 1 is a view of a section of piping or pipeline in need of repair or reinforcement that has been wrapped with a composite wrap material having an electrically conductive portion in communication with a voltage source. In one embodiment, the composite wrap is directly applied to the pipeline surface (see FIG. 2). In another embodiment, the composite wrap is insulated from the pipeline surface (see FIG. 3). Curing of the composite wrap material is accelerated by flowing electricity through fibers integrally contained within the composite wrap.

FIG. 2 is cross-section view of a preferred embodiment illustrating a single layer of the composite wrap material with its electrically conductive fibers wrapped about the pipeline.

FIG. 3 is a cross-section view of another preferred embodiment in which the layer of composite wrap material is insulated from the pipeline surface.

FIG. 4 is a view of the embodiment of FIG. 3 in which a second layer of composite wrap material is wrapped about the first layer of composite wrap material.

FIG. 5 is a view of the embodiment of FIG. 3 in which a second layer of composite wrap material is insulated from the first layer of composite wrap material.

FIG. 6 is a view of the embodiment of FIG. 2 in which the electrically conductive portion encircles an end portion of the composite wrap material.

FIG. 7 is a view of the embodiment of FIG. 3 in which an electrically conductive portion encircles an end portion of the composite wrap material.

FIG. 8 is an enlarged view of the electrically conductive portion of FIG. 3. Rather than encircling an end portion of the composite wrap material (as in FIG. 7), the electrically conductive portion is a tab-like structure in communication with the composite wrap.

FIG. 9 is an enlarged view of the electrically conductive portion of FIG. 2. Rather than encircling an end portion of the composite wrap material (as in FIG. 6), the electrically conductive portion is a tab-like structure in communication with the composite wrap.

### DETAILED DESCRIPTION OF THE PREFERRED EMBODIMENTS

Preferred embodiments of a system and method made according to this invention for fast curing of a composite wrap will now be described by making reference to the drawings and the following elements illustrated in the drawings:
10 Fast cure system
20 Composite wrap
21 Electrically conductive fibers
23 First layer
25 Second layer
30 Tab
31 Leads
33 Voltage source
40 Insulation

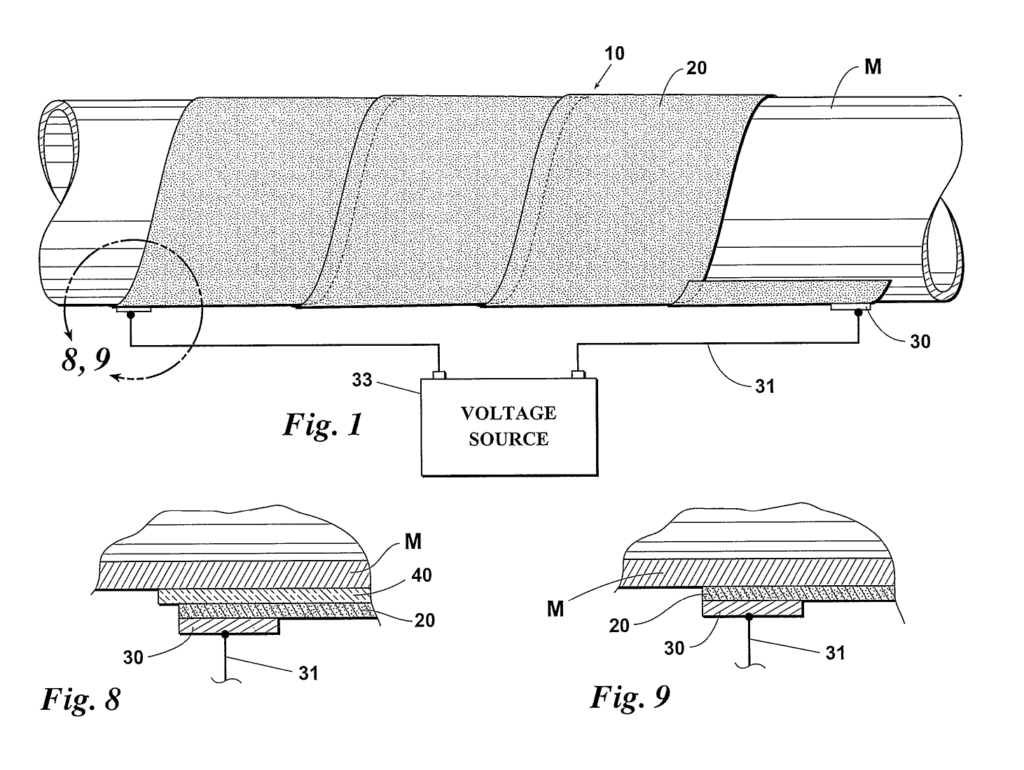

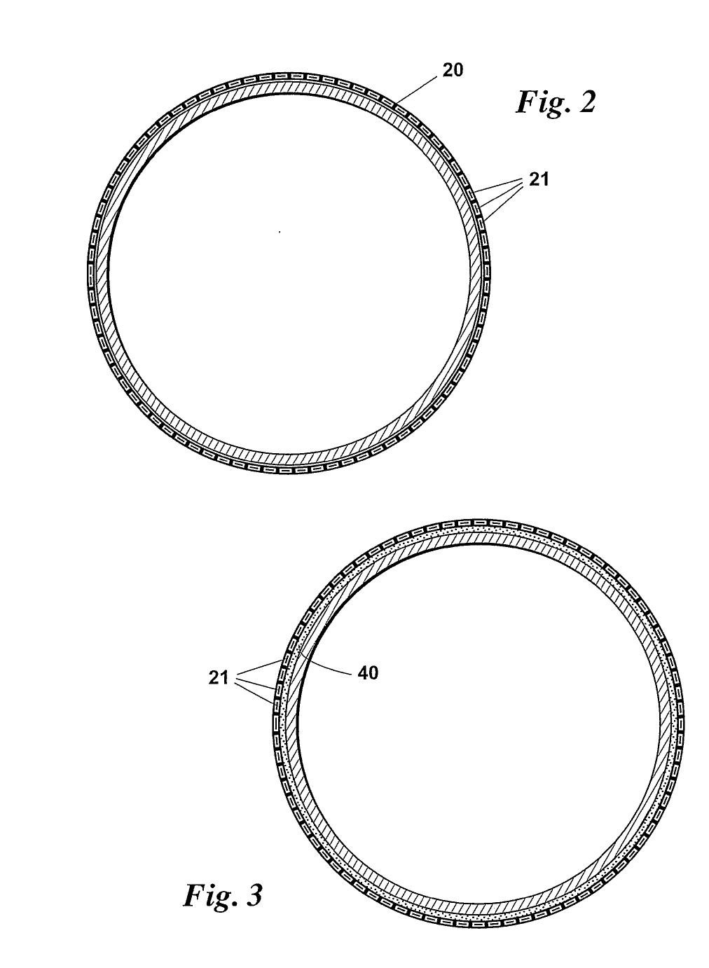

Referring to the drawings and first to FIGS. 1 & 2, fast cure system 10 is applied to a member M, which may be a pressure vessel or a section of straight or curved piping or pipeline—or a structural shape including but not limited to a square, I-beam, or flat plate—in need of repair or reinforcement. Fast cure system 10 includes a composite wrap 20 and two tabs 30 connected by leads 31 to a voltage source 33. When in a wet or uncured state, one or more layers of composite wrap 20 is wrapped about member M so that composite wrap 20 adequately spans the portion of member M in need of repair or reinforcement. The tabs 30 are then applied to the wrapped but uncured composite wrap 20. Voltage source 33 creates a voltage differential across the tabs 30 and the electrical resistance provided by the electrically conductive fibers 21 of composite wrap 20 generates an electrical current in response. As the electrical current passes through the electrically conductive fibers 21, which are typically carbon fibers integral to composite wrap 20, heat is generated within the composite wrap 20 that serves to significantly reduce cure time. When compared to the typical cure time of composite wrap 20 at ambient temperature conditions, tests revealed that fast cure system 10 reduced cure time by an average of four to six hours (a 300 to 500% improvement). Once composite wrap 20 is cured, voltage source 33 is removed.

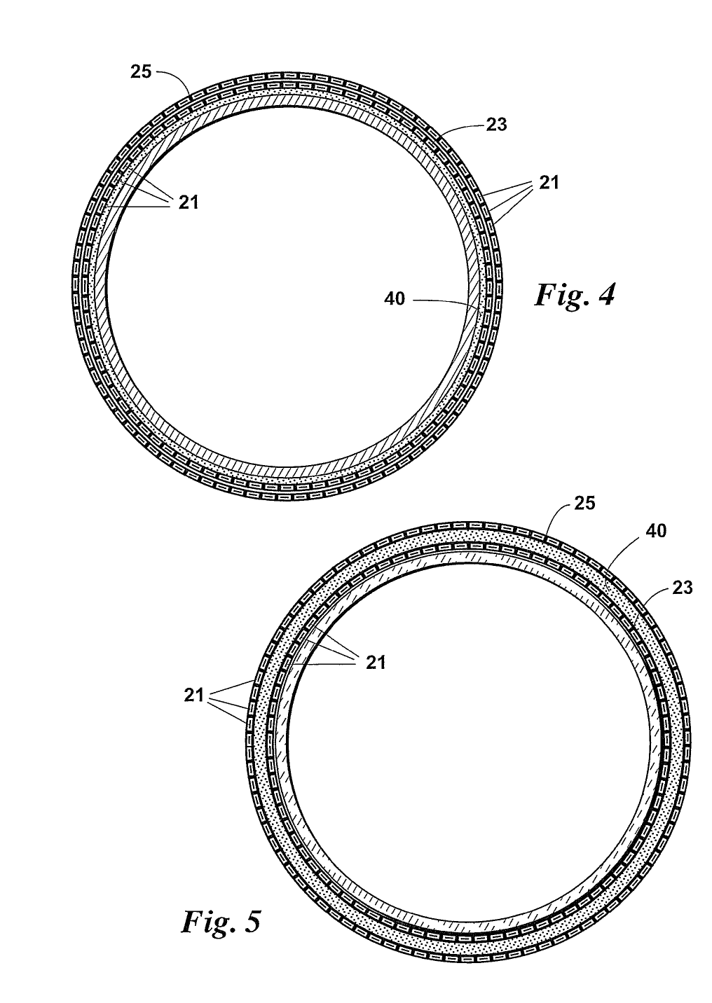

Referring now to FIGS. 3 to 5, one or more layers of insulation 40 may be wrapped about the external surface of member M to insulate the member M from the electrically charged composite wrap 20. A second layer 25 of composite wrap 20 may then be placed directly over and in contact with the first layer 23 of composite wrap 20. Alternatively, insulation 40 may be wrapped about the first layer 23 of composite wrap 20 with second layer 25 wrapped about insulation 40.

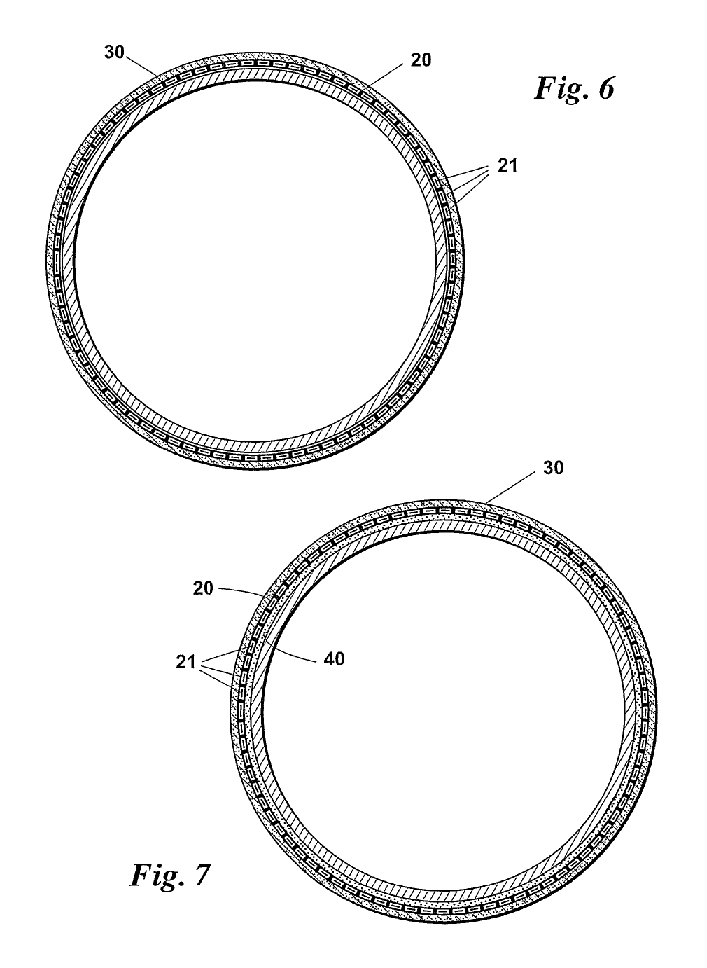

Referring now to FIGS. 1 & 6 to 9, tabs 30 may be localized tabs (as in FIGS. 1 & 9) or may fully encircle a portion of the composite wrap 20 (as in FIGS. 6 to 8). The tabs 30 may be a solid tab or a wire mesh tab.

While a fast cure system and method for curing a composite wrap has been described with a certain degree of particularity, many changes may be made in the details of construction and the arrangement of components without departing from the spirit and scope of this disclosure. A fast cure system and method according to this disclosure, therefore, is limited only by the scope of the attached claims, including the full range of equivalency to which each element thereof is entitled.

What is claimed is:

1. A method for fast curing a composite material, the method comprising the steps of:
wrapping an uncured composite material about an external surface of a structural member so that at least one layer of the uncured composite material encircles a portion of the structural member; and
placing an electrically conductive portion of the at least one layer of the uncured composite material in circuit relationship to a voltage source.

2. A method according to claim 1 further comprising the step of removing the voltage source after the composite material is cured.

3. A method according to claim 1 further comprising the step of providing at least one layer of insulation between the external surface of the structural member and the at least one layer of the uncured composite material, wherein the at least one layer of insulation insulates the structural member from the at least one layer of the uncured composite material.

4. A method according to claim 1 further comprising the step of providing at least one layer of insulation between the at least one layer of the uncured composite material and one or more second layers of uncured composite material, wherein the at least one layer of insulation insulates the at least one layer of the uncured composite material and one or more second layers of uncured composite material from one another.

5. A method according to claim 1 wherein the electrically conductive portion includes two or more tabs, each tab in the two or more tabs being spaced apart from another tab in the two or more tabs.

6. A method according to claim 5 wherein each tab in the two or more tabs encircles a portion the wrapped uncured composite material.

7. A method according to claim 5 further comprising the step of removing the two or more tabs.

8. A method according to claim 1 wherein the at least one layer of the uncured composite material includes a carbon fiber material.

9. A method according to claim 1 wherein the uncured composite material is a pre-impregnated composite material.
